(19) United States
(12) Patent Application Publication
(10) Pub. No.: US 2003/0181561 A1
(43) Pub. Date: Sep. 25, 2003

(54) Dense inorganic fine powder composite film, preparation thereof and articles therefrom

(76) Inventors: Xiaolong Li, Beijing (CN); Lining Ye, Beijing (CN); Yongxiang Zhang, Beijing (CN)

Correspondence Address: Finnegan, Henderson, Farabow,, Garrett & Dunner, L.L.P., 1300 I Street, N.W., Washington, DC, 20005-3315, US

(21) Appl. No.: 10/317,097

(22) Filed: Dec. 12, 2002

(30) Foreign Application Priority Data
Dec. 13, 2001 (CN) 01143574.7

(51) Int. Cl. C08K 3/26; C08K 3/18; C08K 3/22; C08K 3/34; C08K 3/40; C08K 3/04

(52) U.S. Cl. 524/425; 524/495; 524/492; 524/494; 524/447; 524/430

(57) ABSTRACT

A dense inorganic fine powder composite film comprising, based on the total weight of the film, 95-99.9 wt % of inorganic powder material and 0.1-5 wt % of PTFE. This composite film is prepared by dry blending, wet mixing and roll milling, and can be used as electrode materials, adsorbing materials, catalyst materials and dielectric materials.

### TECHNICAL FIELD

This invention relates to a dense inorganic fine powder composite film, to a process for preparing the same, and articles made from the same. More particularly, this invention relates to a dense inorganic fine powder composite film bonded by a small amount of polytetrafluoroethylene (hereinafter referred to as PTFE), a process for preparing the same, and articles made from the same. These articles can be used as electrode materials, dielectric materials, adsorbing materials and catalyst materials etc.

### BACKGROUND ART OF THE INVENTION

It is well known that, owing to a low price and being available easily, the inorganic-filled film containing carbon powder and silica etc. can be used in various fields. And it is known that the addition of a binder such as PTFE can facilitate the bonding together of the inorganic powder. PTFE exhibits a lot of excellent properties such as a good chemical stability, good high temperature stability, good physical-mechanical properties, electric insulating property, high hydrophobicity and lubricity. By adding PTFE into an inorganic material, a PTFE-filled article is formed, thus its lubricity, wear resistance, creep resistance and impact strength can be greatly improved. However, an excess of PTFE can destroy the properties of the inorganic material itself, for example, reducing sharply hardness, porosity and process-ability of the materials.

U.S. Pat. No. 4,194,040 discloses a sheet made of a mixture of 1-15 vol % of fibrillated PTFE matrix and 85-99 vol % of the particulate material entrapped or interconnected by PTFE. The mixture was dry mixed in a ball mill for as long as 30-60 min, so the impact and press of the mill balls greatly deformed or destroyed the structure of particulate materials, thereby deteriorating the property of the particulate materials. Besides, a higher content of PTFE is required to entrap or interconnect the particulate materials, thus the aforesaid trouble cannot be avoided.

U.S. Pat. No. 5,478,363 discloses a process for preparing an electrode material, wherein metal oxide particles (average particle size 20-50 μm) and PTFE particles (average particle size <˜20 μm) were dry blended without a lubricating fluid. In the case of a dry blending and a dry pressing, it is difficult to mix well to form a uniform and dense structure. It is also difficult for simply dry blending to make the PTFE's binding effect in full play. So a higher content of PTFE is required to achieve the desired binding effect, which, however, inevitably has an adverse influence on the electrochemical response characteristics of the materials. In addition, there exist many networks and pores in the film formed according to said patent, and the density was too low (See FIGS. 2-3). The process according to said patent is disadvantageous for a continuous mass production. Owing to a low adsorbance per volume, the application of the film was restricted and the film is unsuitable for use as adsorbing materials such as the adsorbing films for hydrogen, liquefied petroleum gas and natural gas. Besides, WO 97/20881 (Gore & Assoc., INC.) discloses an article obtained by filling PTFE with nm grade inorganic particulates. In order to maintain the basic properties of the porous PTFE, the content of the inorganic particulates can only reach 50 wt % at the most, and PTFE must be the matrix in said article. The article was prepared in a process comprising a wet mixing and a stretching. Scanning electron microscopic analysis on the PTFE article shows that, the nm grade particulates did not fill the pores of the PTFE, thereby appearing a very loose, wiredrawn and network structure.

Therefore, it is necessary to provide an inorganic fine powder filled film having a dense structure, uniformly distributed particulates and a very low PTFE content. The inorganic fine powder filled film according to the present invention not only can exhibit the physical and chemical properties of the inorganic particulates themselves to a greater extent, but also can maintain a fairly high working strength.

### DISCLOSURE OF THE INVENTION

It is an object of this invention to provide an inorganic fine powder composite film having a dense structure, uniformly distributed particles and a very low PTFE content.

A further object of the invention is to provide a process for preparing the inorganic fine powder composite film having a dense structure, uniformly distributed particles and a very low PTFE content.

A still further object of the invention is to provide various articles made from the inorganic fine powder composite film, such as electrode materials, adsorbing materials, dielectric materials and catalyst materials.

In addition, depending on the properties of the inorganic particulate materials, the inorganic fine powder composite film according to the present invention can also be used as magnetic materials and super-conducting materials.

The dense and uniform inorganic fine powder composite film according to the invention comprises, based on the total weight of the film, 95-99.9 wt % of inorganic particulate materials and 0.1-5 wt % of PTFE.

According to a preferred embodiment of the invention, the inorganic fine powder composite film according to the invention comprises, based on the total weight of the film, 97-99.9 wt % of inorganic particulate materials and 0.1-3 wt % of PTFE.

The inorganic particulate materials suitable for the invention include, but not limited to, carbonaceous material, siliceous material, metal, metal oxide and metal sulfide and metal titanate etc. The preferred particulate materials comprise carbon, active carbon, titanium dioxide, copper oxide, ferrous oxide, molybdenum sulfide, barium titanate, strontium titanate, Kaolin, silica, mica, silicon carbide, vermiculite, calcium carbonate, casein, zein, or mixtures thereof. The more preferred particulate materials comprise carbon, active carbon, titanium dioxide, barium titanate or mixtures thereof. The particle size of the particulate materials suitable for the invention is not particularly limited, preferably being 2 nm-0.2 mm.

The PTFE suitable for the invention is preferably a PTFE dispersion resin powder. The particle size of the PTFE suitable for the invention is not particularly limited, preferably being 300-600 μm.

The process for preparing the inorganic fine powder composite film according to the invention comprises the following steps:

a) dry blending 95-99.9 parts by weight of the inorganic particulate materials with 0.1-5 parts by weight of the PTFE resin powder to obtain a mixture;

b) adding to the mixture 90-1000 parts by weight of a solvent, agitating-mixing to form a paste mass; and

c) mixing the paste mass at 60-120° C.

According to a preferred embodiment of the invention, the dry blending in step

a) is carried out at a high revolution (500-3500 rpm), and the agitating-mixing in step b) is carried out at a low revolution (50-500 rpm).

According to a further preferred embodiment of the invention, step c) is carried out in an open mixing mill for a period of 2-10 min, preferably 3-5 min.

According to a particularly preferred embodiment of the invention, the dense inorganic fine powder composite film is prepared as follows:

a) the particulate materials and PTFE are fed into a high-speed agitator-blender, dry blended at a high revolution of 500-3500 rpm for 5-30 min, preferably 10-15 mm;

b) 1-10 times the weight of the powder materials of a boiling solvent (such as water, alcohol or any other solvent non-reactive with the particulates, preferably water, alcohol or any other solvent pre-heated to 60-100° C. prior to the addition) and the aforesaid mixture are added into a low speed high-torsion agitator (such as a kneader), agitated-blended at 50-500 rpm, preferably for 2-10 min to form a paste mass;

c) the paste mass is mixed and milled at 60-120° C. between the rolls at different revolutions in an open double roll mixing mill for 3-5 min to form a strip; and

d) the strip is pressed to form a film having a desired thickness.

By gradually reducing the roller pitch of the open double roll mixing mill, mixing and calendering for 2-3 min, a film having a thickness of about 1 mm is formed. By adjusting the width of the baffle as desired (such as 100/200 mm), the film can be pressed to be as thin as 0.05 mm, or by adjusting the roller pitch of another double roller press, the film can be pressed to the desired thickness. Several layers of the obtained film can also be laminated to the desired thickness.

According to an embodiment of the present process, several layers of the strip from step c) can be bonded to each other and then pressed to form a laminate.

According to a further embodiment of the present process, the strip from step c) can be cut into a strip and then extruded and pressed at a temperature of 60-120° C. in a screw extruder and double roll mixing mill or a double roll calender.

According to the invention, 0.5-1 wt % of the additives well known in the art, such as a lubricating agent, antioxidant and thermal stabilizer etc. can be added into the mixture in step a) to facilitate the modification of the film.

A very small amount of PTFE dispersion resin solid powder is used as the binder in the invention and the film made from the particulate materials has a dense structure in which particles are uniformly distributed. According to the process of the invention, on the one hand, the amount of PTFE can be reduced (as low as 0.1 wt % of PTFE dispersion resin solid powder, based on the total weight of the particulates), and on the other hand, the binding effect of PTFE is improved, thus ensuring the fairly high mechanical property (such as working strength) of the film. In addition, owing to the minute amount of PTFE as a “blending material” in the inorganic materials, the purity of the inorganic material is relatively increased, and the effect of PTFE on the properties of the inorganic material as a matrix is weakened and the properties partly are improved correspondingly.

When tested, the permeability coefficient (flow resistant permeability coefficient) of the inorganic fine powder composite film according to the invention is lower than 1.0'10⁻¹⁴ m², preferably 1.0×10⁻¹⁶−1.0×10⁻¹⁴ m², and the permeability is lower than 1.0×10⁻⁴L/(min·cm²·Pa), preferably 1.0×10⁻⁶−1.0×10⁻⁴L/(min·cm²·Pa).

The particle size of the inorganic particulate materials used in the invention can be up to 0.2 mm, and down to 2 nm. Therefore, the invention can find its use in many fields. The film according to the invention, as compared with the powders prior to processing, maintains an unchanged strength and becomes a dense film with a very high density. Thus the defect of being inconvenient to use of the fine powder material itself due to the looseness of the fine powder is removed. Their applications have extended from laboratory to a mass production.

In the process according to the invention, a dense inorganic fine powder composite film can be made without the high temperature sintering and stretching. In general, depending on the application field and the purpose of the application, the inorganic fine powder composite film can be formed into particular shapes, such as roll, sandwich and in the form of a single layer or multi-layer laminate. The composite film can also be used directly or packed into a given container for use. In this way, not only the processing of the composite film is simply and easy, but also the composite film in various forms can find its use in various fields.

Although it is not intended to be bounded by any theory, it is believed that, the mixing at an open mixing mill at a suitable temperature is critical for the formation of the uniform and dense film. By mixing, a very thin inlaid micro-membrane made from PTFE resin powder is formed randomly in the irregular regions among the inorganic particulates, and in the case of a dense arrangement of the particulates, the particulates are completely and effectively adhered and bound to each other by the uniform and inlaid PTFE membrane. After an intense mixing, substantially uniform and discrete distributed PTFE is apparently formed at and closely bound to the periphery of the particulates at the thickness of about 1/10-1/100 of the particle diameter. And the PTFE exists at the peripheries between the particulates. The effective, and unique binding constitutes the result of the invention. The mixture of particulates and PTFE shall be dry blended and wet mixed in the pre-treating step prior to being fed into an open mixing mill.

Further, while inorganic particulates of no more than 50 wt % by weight of the polymer can be filled according to the prior art, such a restriction is not suitable for the composite film of the invention. In addition to that, the composite film can be produced unprecedently in an open mixing mill.

### BRIEF DESCRIPTION OF THE DRAWINGS

FIG. 1 is a photomicrograph of the material produced in accordance with U.S. Pat. No. 4,153,661.

FIG. 2 is photomicrographs (at different magnifications) of the film made by dry blending, kneading active carbon (av. particle size 50 μm) and 1 wt % of PTFE in accordance with U.S. Pat. No. 5,478,363.

FIG. 3 is photomicrographs (at different magnifications) of the electrode material made by dry pressing the film shown in FIG. 2 which was obtained by dry mixing and kneading (FIG. 2).

FIG. 4 is a photomicrograph (at different magnifications) of the inorganic fine powder material given in example 1 before open mixing milling.

FIG. 5 is a photomicrograph (at different magnifications) of the open mixing milled inorganic fine powder material given in example 1.

FIG. 6 is a photomicrograph (×10,000) of the inorganic fine powder material given in example 3 before open mixing milling.

FIG. 7 is a photomicrograph (×10,000) of the inorganic fine powder material given in example 3 after open mixing milling.

FIG. 8 is X-ray diffraction pattern of the material given in example 2, (a) the unprocessed powder, (b) the resulting film.

FIG. 9 is X-ray diffraction pattern of the material given in example 3, (a) the unprocessed powder, (b) the resulting film.

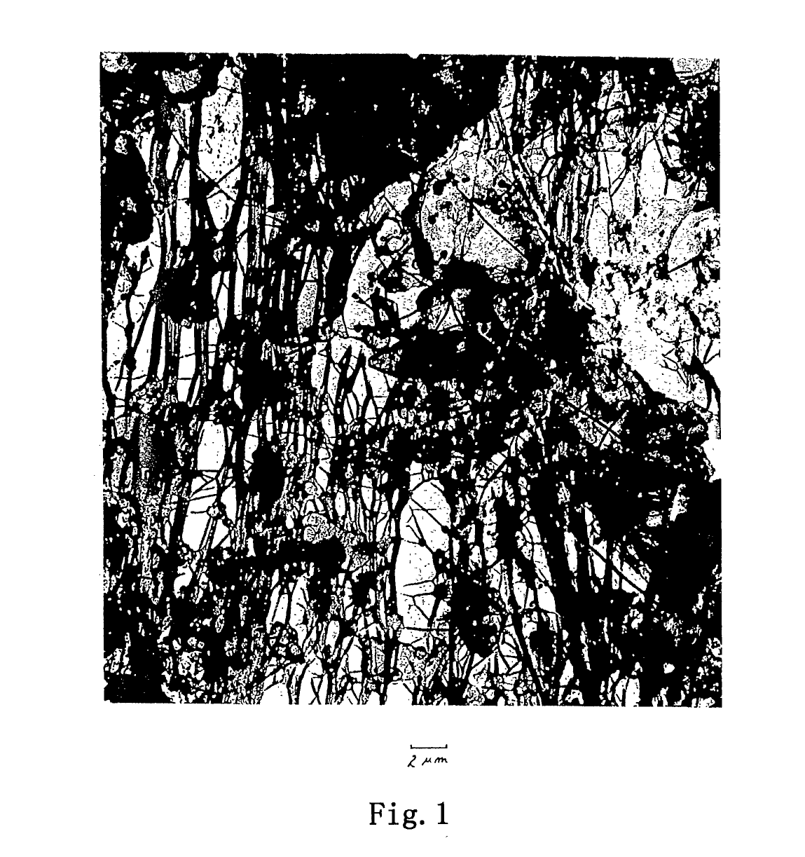

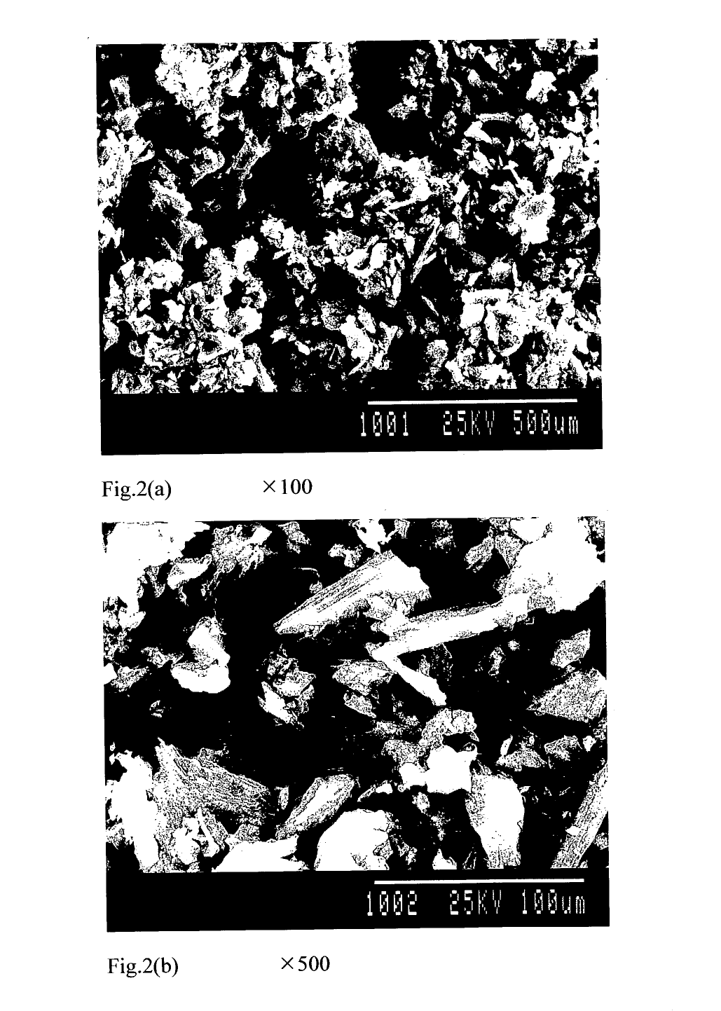

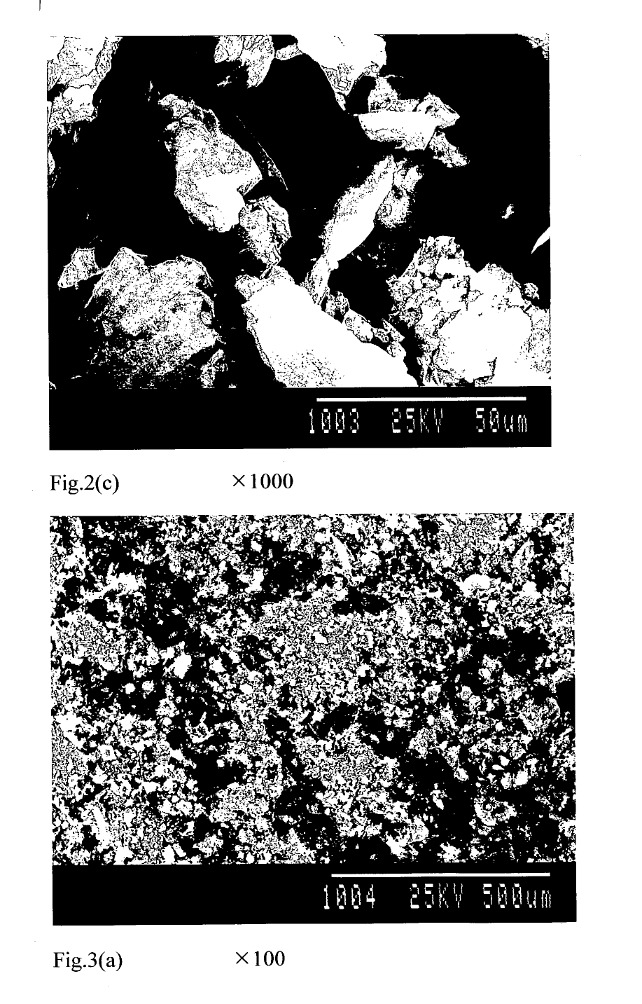

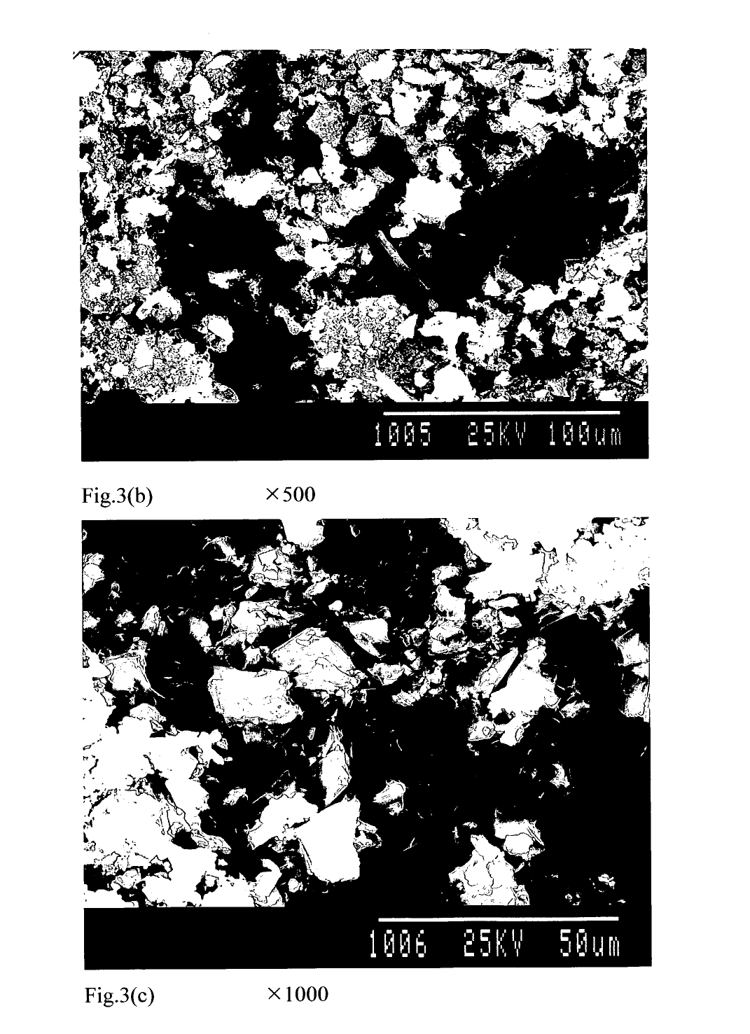

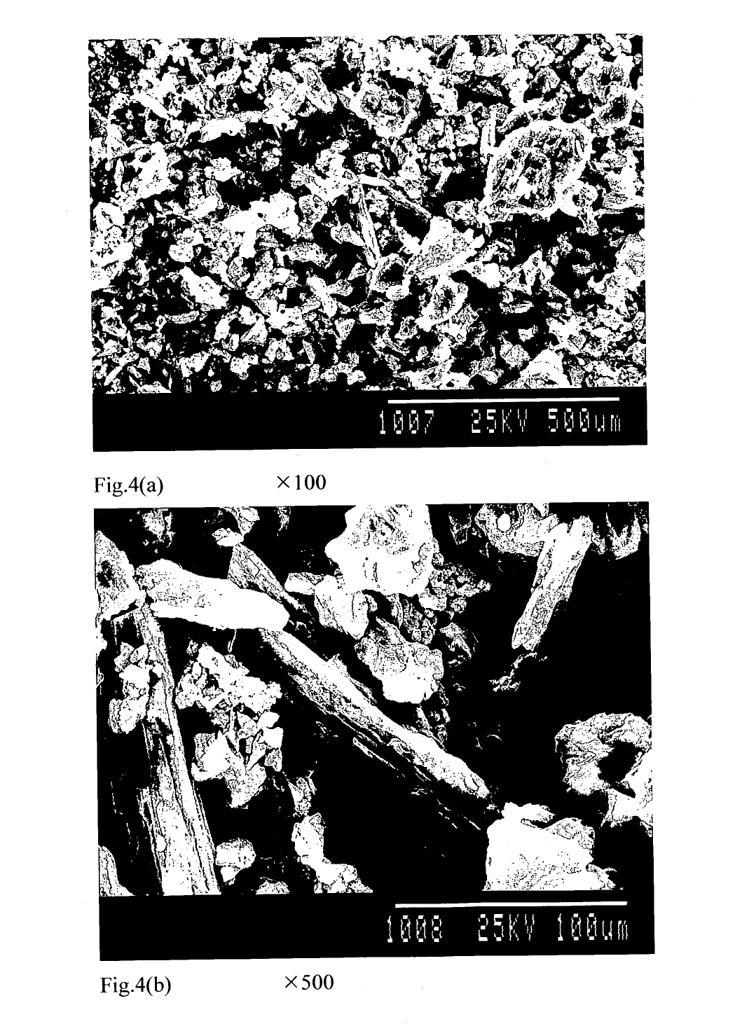

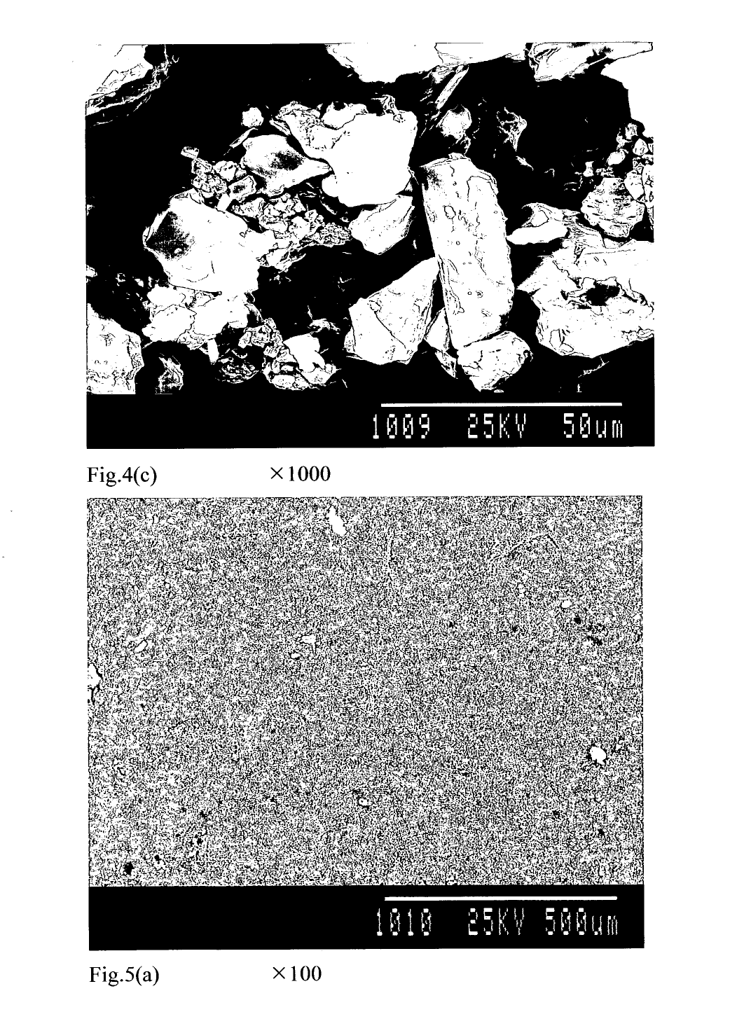

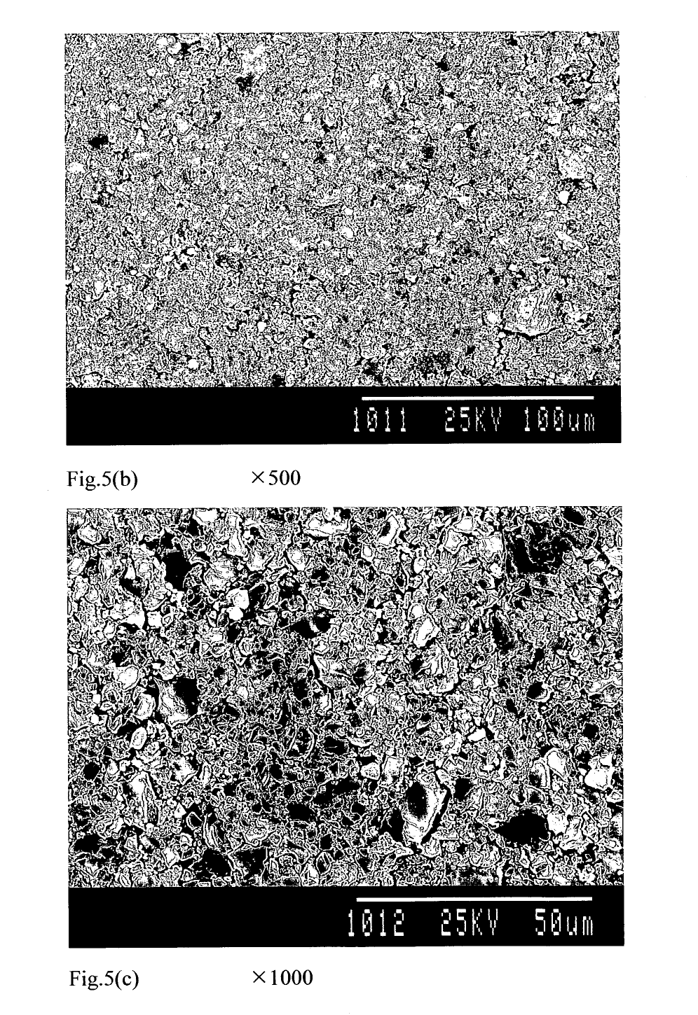

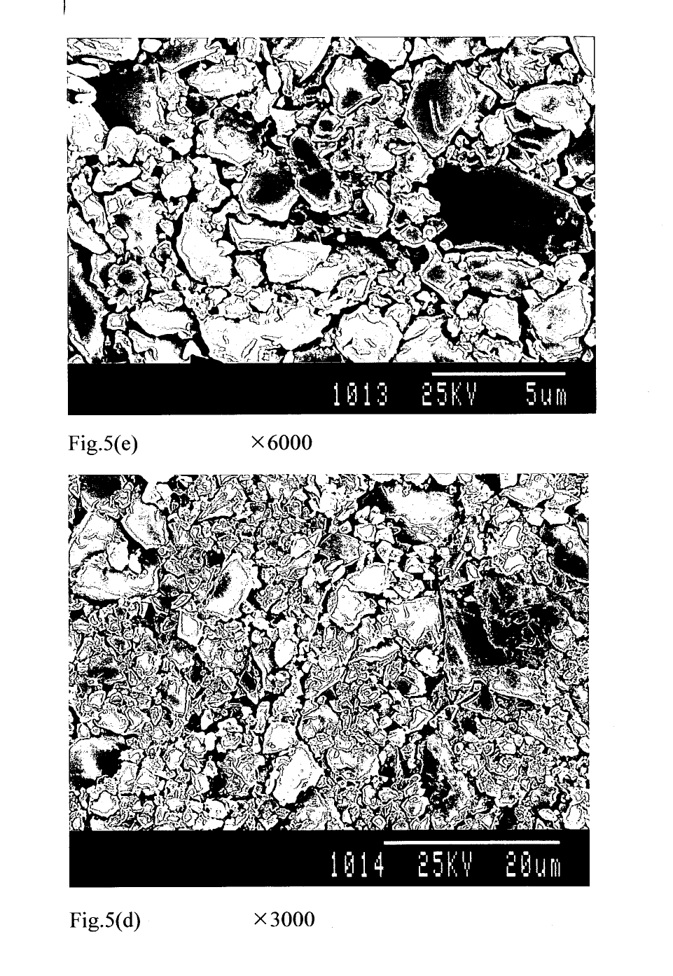

As seen from FIG. 1, the material produced in accordance with U.S. Pat. No. 4,153,661 has a very loose structure. As seen from FIG. 2 and FIG. 3, a dense and uniform structure of particulate cannot be formed with the method described in U.S. Pat. No. 5,478,363. As seen from FIG. 4 and FIG. 5, the inorganic fine powder materials according to the invention, before the open mixing milling, appear a fairly loose structure of non-uniformly distributed particulates, while after the open mixing milling, a dense and uniform structure is formed.

### PREFERRED EMBODIMENTS OF THE INVENTION

The invention will now be further described by the following examples. The measurement and devices employed are as follows.

Electric Capacity Measurer (ARBIN Co., USA) is adopted to measure the electrostatic capacity (electrolyte, 6M KOH aqueous solution).

DMAX/RB X-ray Diffractometer (RIGAKA, JP) is adopted to measure the X-ray diffraction pattern.

S-530 Scanning Electron Microscope (HITACHI, JP) is adopted to obtain photomicrographs.

Micromeritics ASAP 2010 Rapid Specific Surface Area & Pore Size Distribution Measurer (Mack Co., USA) is adopted to obtain (BET method) the specific surface area and average pore size.

PBR Bubble Pore Size and Permeability Measurer (Beijing Main Research Institute of Iron & Steel, China) is adopted to obtain permeability data (according to national standard GB/T 5250-93, commercial canned N₂, 1000 Pa, room temp.)

Hydrogen Gas Adsorption measurer: liquid nitrogen insulation can, H₂ pressure 3 MPa.

Tensile Strength: measured according to ASTM D 5034-1990.

### EXAMPLE 1

20 g of active carbon powder(average particle size: 100 μm, bulk density: 0.4 g/cm³, specific surface area: 1200 m²/g, average pore size: 2.86 nm) and 0.2 g of PTFE dispersion resin powder (particle size: 450 μm) were weighed, then fed into a high-speed agitator-blender (blade revolution: 1200 rpm) and agitated for 10 min to form a well-blended particulate. At that moment, the amount of binder used was less than 1% by total weight of the mixture.

150 ml of boiled de-ionized water and the aforesaid agitated-blended particulate were poured successively into a low-speed high-torsion agitator-kneader (revolution: 200 rpm) and agitating-blending for 5 min to form a paste mass wherein the network could be seen (see FIG. 4).

The paste mixture was then open mixing milled at 80° C. between the rolls of an open double roller mixer for 5 min, and finally formed into a strip shape by gradually reducing the roller pitch (see FIG. 5).

The strip shape was milled again at the same temperature as in the open mixing mill by adjusting the roller pitch, and formed into a film having a thickness of 0.125 mm. When tested, the density of the film was 0.81 g/cm³ and the specific surface area of the film was 1065 m²/g. As Compared with active carbon powder materials, the specific surface area decreased by 12% only, and the density increased more than 100%. The average pore size of the film was 2.84 nm, the permeability was 2.55×10⁻⁵L/(min·cm²·Pa), and the permeability coefficient was 8.58×10⁻⁵m², about 1000 times smaller than the common sintered metal materials. It is known that the magnitude of the permeability coefficient of the common sintered dense metal materials is 10⁻¹²).

The active carbon powder film thus made was used as electrode materials and formed into a double layer capacitor. When tested, its capacitance was 55 F/g, increased by 20-30% as compared with the capacitor obtained by using conventional active carbon fibre cloth or mat.

### EXAMPLE 2

20 g of high specific surface area active carbon powder (average particle size: 50 μm, bulk density: 0.4 g/cm³, specific surface area: 3050 m²/g) and 0.2 g of PTFE dispersion resin powder (particle size: 450 μm) were weighed, then fed into a high-speed agitator-blender (blade revolution: 1200 rpm) and agitated for 10 min to form a well-blended mixture. At that moment, the amount of binder was less than 1% by total weight of the mixture.

The same operation as in example 1 was carried out to form a strip having a thickness of 0.3 mm. The strip has a silk-like feeling with no wet feeling, good self-supporting property, and a dense structure.

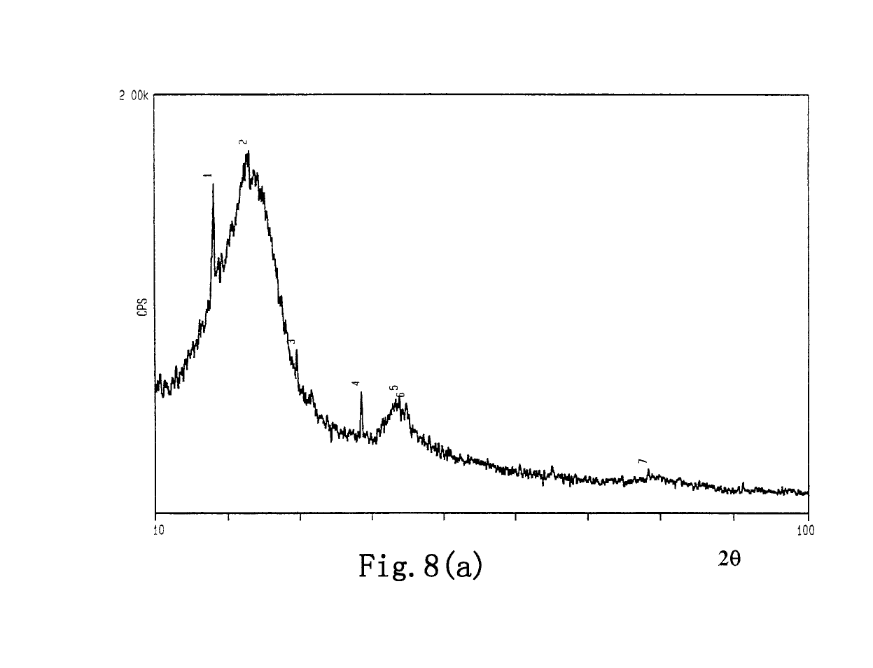

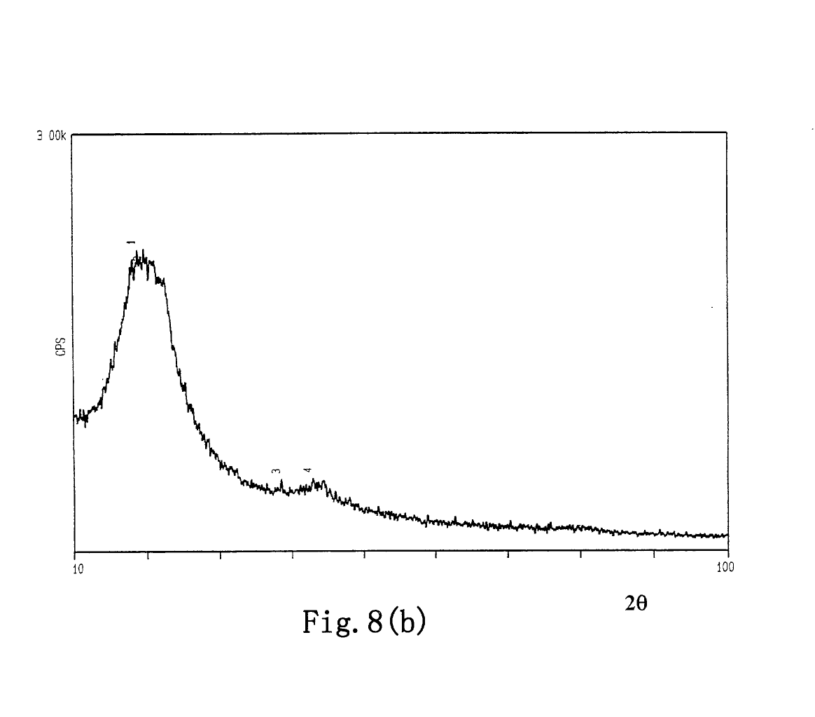

The average pore size of the powder to be processed was 2.37 nm, H₂ adsorbance being 7 wt % (i.e. 7 g of H₂ can be adsorbed by 100 g adsorbent). The average pore size was 2.36 nm, the density of the film was 0.92 g/cm³, the specific surface area was 2560 m²/g, and H₂ adsorbance of the resulting film was 6.5 wt %. Therefore, with a substantially unchanged inner structure of the powder, if an equal amount of H₂ is adsorbed, the volume occupied by the film would be the half as large as that of the powder to be processed. Therefore, the film can be used as H₂ adsorbing materials, and in addition, can also be used as natural gas-adsorbing materials and liquefied petroleum gas-adsorbing materials. Owing to the obvious space-saving advantage, the film can be used in a power car as a part of the energy-storage tank. When used in H₂ adsorption, owing to the high adsorbance, the film can be used under a gaseous hydrogen condition, without the need of a high pressure for ordinary liquid H₂ storage, and thus the process is greatly simplified and the cost is cut down. When tested, the tensile strength of the film was 2.2(N) breaking force (a random sampling method) indicating that the film has a good self-supporting property. The permeability was 1.244×10⁻⁵L/(min·cm²·Pa), and the permeability coefficient was 3.80×10⁻¹⁵m², which was about 1000 times smaller than the common sintered metal materials. As shown in FIG. 8, around the processing, the maximum diffraction peaks of both the powder and the film appeared at 2θ32 21.84.

As seen from the above result, compared with the powder material, the specific surface area of the film only decreased by 16%, and the density increased more than 100%. It proved that, after the process of preparation such as mixing, a denser inorganic composite film can be formed and its larger specific area can be maintained. Meantime the original phase structure of the particulate has not been changed during the process.

In addition, this film can also replace the active carbon cloth or mat of high surface area. And the electrostatic capacitance of the capacitor made thereof can reach 175 F/g or higher which is 3-4 times larger than that of the capacitor made of the film described in WO 97/20881. Owing to its smooth and dense surface, naturally, the film can contact with lead-out electrode very closely. As compared with the case for the active carbon fibre cloth Kynol-20 (Japanese), the encapsulation pressure can be decreased by 90%.

### EXAMPLE 3

10 g of nm grade carbon powder (average particle size: 30 nm, bulk density: 0.0625 g/cm³) and 0.2 g of PTFE dispersion resin powder (average particle size: 450 μm) were weighed, then fed into a high-speed agitator-blender (blade revolution: 1200 rpm) and agitated for 10 min to form a full-blended particulate.

The same operation as in example 1 was carried out to form a strip having a thickness of 0.3 mm. The strip has a silk-like feel and a dense structure. And most water was volatilized.

As can be known from the test, the tensile strength was 4.2(N) breaking force (a random sampling method), and the density was 0.49 g/cm³, which was about 8 times higher than that of the inorganic particulate. The permeability of the film was 1.22×10⁻⁶L/(min·cm²·Pa), and permeability coefficient was 1.80×10⁻¹⁶m². The permeability was about 10,000 times smaller than the common sintered metal material.

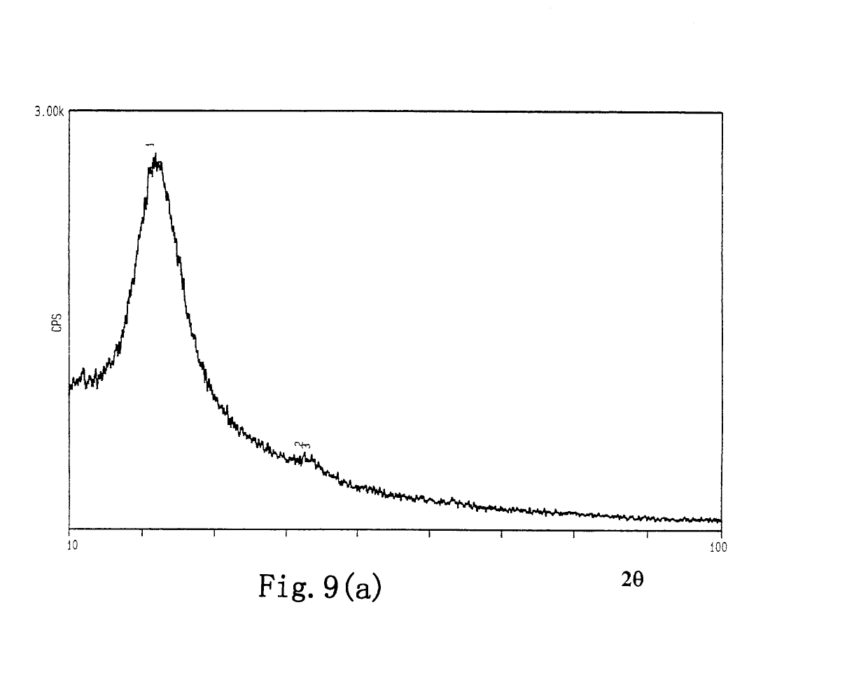

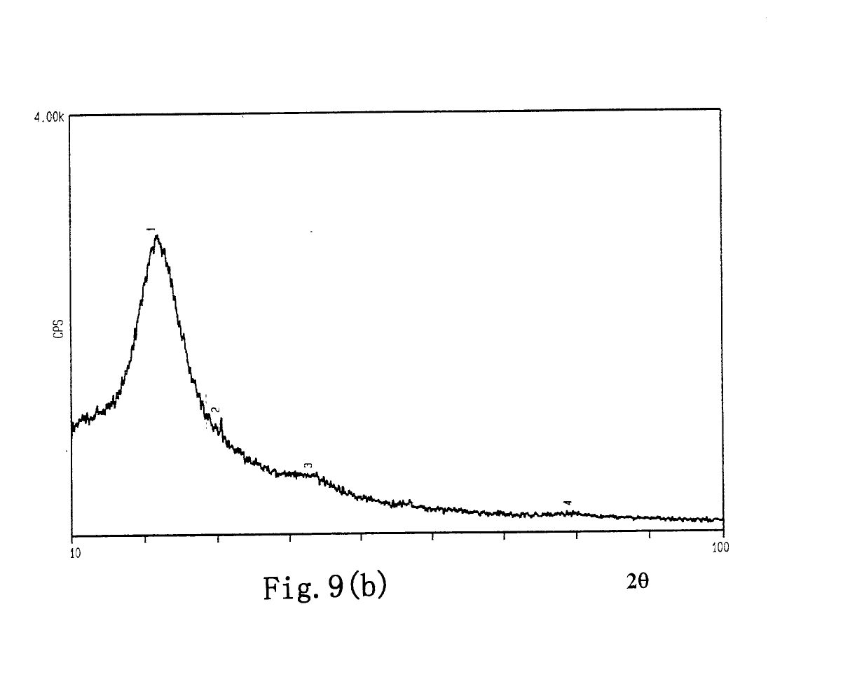

As shown in FIG. 9, the maximum diffraction peaks of both the powder to be processed and the obtained film appeared at 2θ=21.84.

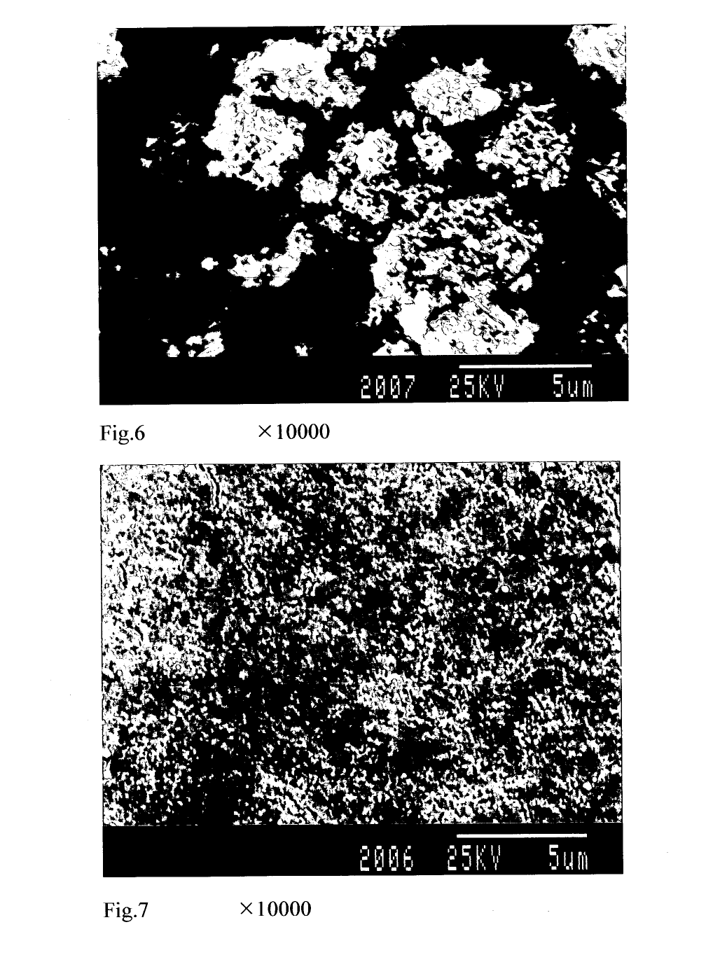

The photomicrographs of the inorganic particulate to be processed and the obtained film were shown respectively in FIG. 6 and FIG. 7.

The measured average pore size of the inorganic particulate and film were 5.6 nm and 5.4 nm respectively. It proved that the interior structure of inorganic material has substantially not been changed by the preparation method of the invention, and the phase structure of the unprocessed inorganic material was substantially identical to that of the processed one. The film thus made can be used as an adsorbent and electrode material. The electrostatic capacitance of the capacitor, which was made of the present electrode material, was determined as 65 F/g.

### EXAMPLE 4

40 g of titanium dioxide (TiO₂) powder (particle size: 1˜5 μm) and 0.2 g of PTFE dispersion resin powder (average size: 450 μm) were weighed, and fed into a high-speed agitator-blender (blade revolution: 1200 rpm), and agitated for 5 min to form a full-blended particulate. After 2 g of releasing agent powder resin was added, the resulting mixture was agitated for another 30 sec.

Except that the volume of water was changed to 50 ml, the same operation as in example 1 was carried out, and then a dense strip-like film was finally formed. Most water was volatilized.

### EXAMPLE 5

The same condition as in example 1 was used to prepare the inorganic fine powder composite film which can be used as an electrode material, except that the PTFE content was 0.2 wt % and the average pore size of the inorganic particulate was 2.2 nm. The density of the resulting film was 0.92 g/cm³, i.e., was increased more than 200%. The obtained inorganic fine powder composite film can be used as an electrode material of capacitor, battery and the like.

### EXAMPLE 6

The same conditions as in example 3 were used to prepare the inorganic fine powder composite film which can be used as an adsorbing material. The inorganic material used was nm grade powder of carbon (diameter: 21 nm, bulk density: 0.03 g/cm³). The density of the resulting film was 0.43 g/cm³, i.e., increased by 14 times or more as compared with that of the powder material.

### EXAMPLE 7

The same condition as in example 2 was used to prepare the inorganic fine powder composite film which can be used as an adsorbent, except that the bulk density of the inorganic material was 0.25 g/cm³. Before processing, the H₂ adsorption capacity of the powder was about 7 wt %, but the powder had a low bulk density and occupied a very large space. After processing, an inorganic composite film (the H₂ adsorption capacity of the film was 6 wt %; and bulk density increased by 3 times, to 0.92 g/cm³) was formed, and can be used as an energy-storage tank for a fuel cell to adsorb H₂. And thus it is possible that H₂ can be fed into a compact fuel cell vehicles using such an energy-storage tank.

### EXAMPLE 8

Except that 50 g of Barium titanate fine powder (particle size: 3-5 μm) and 2.5 g PTFE dispersion resin powder were used and wet mixed with 20 ml of water, the same condition as in example 4 was used to form a dielectric film having a thickness of 0.25 mm. When tested, the dielectric constant of the unprocessed barium titanate fine powder was 1500 (25° C., 1 kHz); and the dielectric constant of the resulting film was over 40 (25° C., 1 kHz). The obtained film was soft, dense, and easy for further processing and usage. In the prior art, however, only not more than 50 wt % barium titanate powder, on the basis of total weight of the film, can be mixing milled together with polypropylene to form a film, and the dielectric constant of the resulting film can only reach 20 (25° C., 1 kHz). In addition, the permeability coefficient of the film was 2.41×10⁻¹⁴ m², and permeability was 2.16×10⁻⁵L(min·cm²·Pa).

### EXAMPLE 9

The belt obtained as in Example 1 was cut into a stripe having a width of 3-5 mm. Liquid petrolatum at an amount of 1% by weight of the total weight of the powder as a starting material was added as a releasing agent. The stripe was extruded in a screw extruder equipped with a die having a width of 100 mm and a thickness of 3 mm at a temperature of 100° C. And a 100 mm wide, 3 mm thick and 5 m long belt-like film was obtained. The belt-like film was placed in a double-roll miller with a roller pitch of 0.125 mm and was pressed at a temperature of 100° C. to form a belt-like film material having a width of 105 mm, a thickness of 0.25 mm and a length of 20 m, which was ready for packaging.

### EXAMPLE 10

Five pieces of the strip were prepared as in Example 1 and bonded to each other with a polyvinyl alcohol adhesive to form a laminate. The laminate was pressed in a double roller mixer with an roll nip of 0.15 mm and a roll temperature of 100° C. to form a roll-like film 0.15 mm thick and 20 m long.

Thus, it can be seen that, according to the invention, there is provided an inorganic fine powder film with a very low content of PTFE which can be subject to various processing for polymers. In addition, the resulting film density as compared with the bulk density of the powder before processing, is greatly changed, thus rendering the film capable of being widely used as electrochemical materials, adsorbing materials, catalyst materials and dielectric materials.

1. A dense and uniform inorganic fine powder composite film which comprises, based on the total weight of the film, 95-99.9 wt % of inorganic powder material and 0.1-5 wt % of PTFE, wherein PTFE is in uniform and discrete distribution.

2. The composite film of claim 1 wherein said inorganic powder material is selected from the group consisting of Kaolin, carbon, active carbon, titanium dioxide, silica, copper oxide, ferrous oxide, mica, molybdenum sulfide, silicon carbide, vermiculite, calcium carbonate, barium titanate, strontium titanate, casein, zein, alumina, garnet, glass, glass fibre, metal, or mixtures thereof.

3. The composite film of claim 2 wherein said inorganic powder materials are at least one of carbon, active carbon, titanium dioxide, barium titanate and mixtures thereof.

4. The composite film of claim 1 wherein the content of PTFE is 0.1-1 wt %.

5. The composite film of claim 1 wherein the permeability is lower than 1.0×10⁻⁴L/(min·cm²·Pa), and the permeability coefficient is lower than 1.0×10⁻¹⁴ m².

6. The composite film of claim 5 wherein the permeability is 1.0×10⁻⁶˜10×10⁻⁴L/(min·cm²·Pa), and the permeability coefficient is 1.0×10⁻¹⁶˜1.0×10⁻¹⁴ m².

7. A process for preparing the inorganic fine powder composite film of claim 1, comprising the following steps:
a) dry blending 95-99.9 parts by weight of inorganic powder material with 0.1-5 parts by weight of PTFE resin powder to form a mixture;
b) adding to the mixture 90-1000 parts by weight of a solvent, agitating-mixing to form a paste mass; and
c) mixing the paste mass at 60-120° C.

8. The process of claim 7 wherein the step a) operates at 500-3500 rpm.

9. The process of claim 7 wherein the step b) operates at 50-500 rpm.

10. The process of claim 7 wherein said solvent in step b) is selected from the group consisting of water, alcohol, or any other solvent non-reactive with the powder material, or mixtures thereof.

11. The process of claim 7 wherein said solvent in step b) is preheated to boil or near to the boiling point just before its addition.

12. The process of claim 7 wherein the step c) is carried out by means of an open double roller mixer.

13. The process of claim 7 wherein the step c) further comprises roll pressing the composite to a desired thickness.

14. The process of claim 7 further comprising step d) the film obtained by mixing is cut into a strip and then extruded and pressed at a temperature of 60-120° C.

15. The process of claim 7 wherein several layers of the film obtained by mixing in step c) are bonded to each other and then pressed to form a laminate.

16. The process of claim 14 wherein step d) is carried out by means of a screw extruder and double roller mixer or double roller calender.

17. An electrode material made from the composite film of claim 1.

18. An adsorbing material made from the composite film of claim 1.

19. A catalyst material made from the composite film of claim 1.

20. A dielectric material made from the composite film of claim 1.
